(19) United States
(12) Patent Application Publication
(10) Pub. No.: US 2023/0289603 A1
(43) Pub. Date: Sep. 14, 2023

(54) NEURAL NETWORK TRAINING METHOD AND APPARATUS

(71) Applicant: HUAWEI TECHNOLOGIES CO., LTD., Shenzhen (CN)

(72) Inventors: Dayong Liu, Shenzhen (CN); Zeyi Huang, Shenzhen (CN)

(21) Appl. No.: 18/322,373

(22) Filed: May 23, 2023

Related U.S. Application Data
(63) Continuation of application No. PCT/CN2021/115204, filed on Aug. 30, 2021.

(30) Foreign Application Priority Data
Nov. 23, 2020 (CN) 202011322834.6

(51) Int. Cl. G06N 3/08

(52) U.S. Cl. CPC G06N 3/08

(57) ABSTRACT

This application relates to the field of artificial intelligence, and provides a neural network training method and apparatus. The method includes: obtaining a to-be-trained neural network; grouping parameters of the to-be-trained neural network, to obtain M groups of parameters, where M is a positive integer greater than or equal to 1; obtaining sampling probability distribution and training iteration step arrangement, where the sampling probability distribution represents a probability that each of the M groups of parameters is sampled in each training iteration step, and the training iteration step arrangement includes interval arrangement and periodic arrangement; freezing or stopping updating a sampled parameter group based on the sampling probability distribution and the training iteration step arrangement; and training the to-be-trained neural network based on the parameter group that is frozen or stopped updating.

### CROSS-REFERENCE TO RELATED APPLICATIONS

This application is a continuation of International Application No. PCT/CN2021/115204, filed on Aug. 30, 2021, which claims priority to Chinese Patent Application No. 202011322834.6, filed on Nov. 23, 2020. The disclosures of the aforementioned applications are hereby incorporated by reference in their entireties.

### TECHNICAL FIELD

This application relates to the field of artificial intelligence, and specifically, to a neural network training method and apparatus.

### BACKGROUND

Deep learning technologies have made great progress in computer vision. Graphics recognition is used as an example. A deep neural network model has been ahead of a conventional computer vision method at a huge advantage in the ImageNet large scale visual recognition challenge (ImageNet large scale visual recognition challenge, ILSVRC) since 2012. An ImageNet (ILSVRC 2012) dataset has about 1.28 million images, and it takes about 8 hours to train 90 rounds on eight V100 compute cards by using a ResNet50 neural network. A GPT-3 model released by OpenAI has about 175 billion parameters and is trained by using 45 TB of data, and the training costs 13 million dollars at a time. As the scale of a dataset becomes larger and there are more network model parameters, more time and money are spent on model training while a model with higher precision is obtained. Therefore, how to accelerate neural network training has become an urgent problem that needs to be resolved.

### SUMMARY

This application provides a neural network training method and apparatus, to implement fine-grained control on a parameter group of a neural network in an iteration step dimension, and improve training precision while training is accelerated.

According to a first aspect, a neural network training method is provided. The method includes: obtaining a to-be-trained neural network; grouping parameters of the to-be-trained neural network, to obtain M groups of parameters, where M is a positive integer greater than or equal to 1; obtaining sampling probability distribution and training iteration step arrangement, where the sampling probability distribution represents a probability that each of the M groups of parameters is sampled in each training iteration step, and the training iteration step arrangement includes interval arrangement and periodic arrangement; freezing or stopping updating a sampled parameter group based on the sampling probability distribution and the training iteration step arrangement; and training the to-be-trained neural network based on the parameter group that is frozen or stopped updating.

According to the neural network training method in embodiments of this application, the parameter group of the neural network is processed in the iteration step dimension, to implement fine-grained control on an acceleration process, and improve training precision while training is accelerated. The parameter group is sampled and processed based on the training iteration step arrangement and the sampling probability distribution, to more flexibly select between training costs and training precision. For example, a corresponding sampling probability may be determined based on specific costs proportion of each group of parameters.

With reference to the first aspect, in some possible implementations, the freezing or stopping updating a sampled parameter group based on the sampling probability distribution and the training iteration step arrangement includes: determining a first iteration step based on the training iteration step arrangement, where the first iteration step is a to-be-sampled iteration step; determining, based on the sampling probability distribution, an m^{th} group of parameters sampled in the first iteration step, where m is less than or equal to M−1; and freezing the m^{th} group of parameters to a first group of parameters in the first iteration step, where the freezing the m^{th} group of parameters to a first group of parameters in the first iteration step indicates that gradient calculation and parameter update are not performed on the m^{th} group of parameters to the first group of parameters.

It is determined based on the sampling probability distribution that some parameter groups are frozen, and gradient calculation and parameter update are not performed. Therefore, the neural network training can be accelerated. For a frozen parameter group, a parameter group in a subsequent iteration step does not need to use, in a period, a parameter of a previously frozen parameter group. This can avoid a momentum offset.

With reference to the first aspect, in some possible implementations, the freezing or stopping updating a sampled parameter group based on the sampling probability distribution and the training iteration step arrangement includes: determining a first iteration step based on the training iteration step arrangement, where the first iteration step is a to-be-sampled iteration step; determining, based on the sampling probability distribution, an m^{th} group of parameters sampled in the first iteration step, where m is less than or equal to M−1; and stopping updating the m^{th} group of parameters to a first group of parameters in the first iteration step, where the stopping updating the m^{th} group of parameters to a first group of parameters in the first iteration step indicates that gradient calculation is performed and parameter update is not performed on the m^{th} group of parameters to the first group of parameters.

It is determined based on the sampling probability distribution that some parameter groups are frozen, and gradient calculation is performed and parameter update is not performed. Therefore, neural network training precision can be improved. Gradient calculation is still performed on the parameter group that is stopped updating, so that a parameter of a corresponding parameter group in a subsequent iteration step can be kept updated. This can avoid a momentum offset.

With reference to the first aspect, in some possible implementations, when the training iteration step arrangement is the interval arrangement, the determining a first iteration step based on the training iteration step arrangement includes: determining a first interval; and determining one or more first iteration steps at every first interval in a plurality of training iteration steps.

With reference to the first aspect, in some possible implementations, when the training iteration step arrangement is the periodic arrangement, the determining a first iteration step based on the training iteration step arrangement includes: determining that a quantity of first iteration steps is M−1; and determining a first period based on the quantity of first iteration steps and a first proportion, where the first period includes the first iteration step and an iteration step to be trained on the entire network, the first proportion is a proportion of the first iteration step in the first period, and the first iteration step is last (M−1) iteration steps in the first period.

According to the neural network training method in embodiments of this application, a to-be-sampled iteration step can be determined in the foregoing two manners. The periodic arrangement can effectively improve a neural network training speed, and the interval arrangement can effectively improve neural network training precision.

According to a second aspect, a data processing method is provided. The method includes: obtaining to-be-processed data; processing the to-be-processed data by using a target neural network, where the target neural network is obtained through training, and the training of the target neural network includes: obtaining the to-be-trained neural network; grouping parameters of the to-be-trained neural network, to obtain M groups of parameters, where M is a positive integer greater than or equal to 1; obtaining sampling probability distribution and training iteration step arrangement, where the sampling probability distribution represents a probability that each of the M groups of parameters is sampled in each training iteration step, and the training iteration step arrangement includes interval arrangement and periodic arrangement; freezing or stopping updating a sampled parameter group based on the sampling probability distribution and the training iteration step arrangement; and training the to-be-trained neural network based on the parameter group that is frozen or stopped updating.

According to the data processing method provided in this application, data is processed by using the neural network obtained through training in the neural network training method according to any one of the first aspect or the implementations of the first aspect, so that a data processing capability of the neural network can be effectively improved.

According to a third aspect, a neural network training apparatus is provided. The apparatus includes: an obtaining module, configured to obtain a to-be-trained neural network; and a processing module, configured to group parameters of the to-be-trained neural network, to obtain M groups of parameters, where M is a positive integer greater than or equal to 1; the obtaining module is further configured to obtain sampling probability distribution and training iteration step arrangement, where the sampling probability distribution represents a probability that each of the M groups of parameters is sampled in each training iteration step, and the training iteration step arrangement includes interval arrangement and periodic arrangement; and the processing module is further configured to: freeze or stop updating a sampled parameter group based on the sampling probability distribution and the training iteration step arrangement; and train the to-be-trained neural network based on the parameter group that is frozen or stopped updating.

Embodiments of this application further provide the neural network training apparatus. The apparatus can be configured to implement the method in any implementation of the first aspect.

With reference to the third aspect, in some possible implementations, that the processing module freezes or stops updating a sampled parameter group based on the sampling probability distribution and the training iteration step arrangement includes: determining a first iteration step based on the training iteration step arrangement, where the first iteration step is a to-be-sampled iteration step; determining, based on the sampling probability distribution, an m^{th} group of parameters sampled in the first iteration step, where m is less than or equal to M−1; and freezing the m^{th} group of parameters to a first group of parameters in the first iteration step, where the freezing the m^{th} group of parameters to a first group of parameters in the first iteration step indicates that gradient calculation and parameter update are not performed on the m^{th} group of parameters to the first group of parameters.

With reference to the third aspect, in some possible implementations, that the processing module freezes or stops updating a sampled parameter group based on the sampling probability distribution and the training iteration step arrangement includes: determining a first iteration step based on the training iteration step arrangement, where the first iteration step is a to-be-sampled iteration step; determining, based on the sampling probability distribution, an m^{th} group of parameters sampled in the first iteration step, where m is less than or equal to M−1; and stopping updating the m^{th} group of parameters to a first group of parameters in the first iteration step, where the stopping updating the m^{th} group of parameters to a first group of parameters in the first iteration step indicates that gradient calculation is performed and parameter update is not performed on the m^{th} group of parameters to the first group of parameters.

With reference to the third aspect, in some possible implementations, when the training iteration step arrangement is the interval arrangement, that the processing module determines a first sampled iteration step based on the training iteration step arrangement includes: determining a first interval; and determining one or more first iteration steps at every first interval in a plurality of training iteration steps.

With reference to the third aspect, in some possible implementations, when the training iteration step arrangement is the periodic arrangement, that the processing module determines a first sampled iteration step based on the training iteration step arrangement includes: determining that a quantity of first iteration steps is M−1; and determining a first period based on the quantity of first iteration steps and a first proportion, where the first period includes the first iteration step and an iteration step to be trained on the entire network, the first proportion is a proportion of the first iteration step in the first period, and the first iteration step is last (M−1) iteration steps in the first period.

According to a fourth aspect, a data processing apparatus is provided. The apparatus includes: an obtaining module, configured to obtain to-be-processed data; and a processing module, configured to process the to-be-processed data by using a target neural network, where the target neural network is obtained through training, and the training of the target neural network includes: obtaining the to-be-trained neural network; grouping parameters of the to-be-trained neural network, to obtain M groups of parameters, where M is a positive integer greater than or equal to 1; obtaining sampling probability distribution and training iteration step arrangement, where the sampling probability distribution represents a probability that each of the M groups of parameters is sampled in each training iteration step, and the training iteration step arrangement includes interval arrangement and periodic arrangement; freezing or stopping updating a sampled parameter group based on the sampling probability distribution and the training iteration step arrangement; and training the to-be-trained neural network based on the parameter group that is frozen or stopped updating.

According to a fifth aspect, an electronic device is provided. The device includes a memory and a processor, where the memory is configured to store program instructions, and when the program instructions are executed in the processor, the processor is configured to perform the method in any implementation of the first aspect and the second aspect.

The processor in the fifth aspect may be a central processing unit (central processing unit, CPU), or may be a combination of the CPU and a neural network operation processor.

According to a sixth aspect, a computer-readable medium is provided. The computer-readable medium stores program code executed by a device, and the program code includes the method in any implementation of the first aspect and the second aspect.

According to a seventh aspect, a computer program product including instructions is provided, and when the computer program product runs on a computer, the computer is enabled to perform the method in any implementation of the first aspect and the second aspect.

According to an eighth aspect, a chip is provided. The chip includes a processor and a data interface, and the processor reads, through the data interface, instructions stored in a memory, to perform the method in any implementation of the first aspect and the second aspect.

Optionally, as an implementation, the chip may further include the memory. The memory stores the instructions, the processor is configured to execute the instructions stored in the memory, and when executing the instructions, the processor is configured to perform the method in any implementation of the first aspect and the second aspect.

The chip may be specifically a field-programmable gate array (field-programmable gate array, FPGA) or an application-specific integrated circuit (application-specific integrated circuit, ASIC).

### BRIEF DESCRIPTION OF DRAWINGS

FIG. 1 is a schematic diagram of a structure of a convolutional neural network according to an embodiment of this application;

FIG. 2 is a schematic block diagram of a system architecture to which a neural network training method is applicable according to an embodiment of this application;

FIG. 3 is a schematic diagram of training iteration steps in interval arrangement according to an embodiment of this application;

FIG. 4 is a schematic explanatory diagram of a momentum offset according to an embodiment of this application;

FIG. 5 is a schematic diagram of training iteration steps in periodic arrangement according to an embodiment of this application;

FIG. 6 is a schematic flowchart of a neural network training method according to an embodiment of this application;

FIG. 7 is a schematic block diagram of neural network parameter grouping according to an embodiment of this application;

FIG. 8 is a schematic block diagram of a neural network training method according to an embodiment of this application;

FIG. 9 is a schematic diagram of sampling training iteration steps in periodic arrangement according to an embodiment of this application;

FIG. 10 is a schematic block diagram of a static graph deep learning framework computation graph according to an embodiment of this application;

FIG. 11 is a schematic diagram of sampling training iteration steps in interval arrangement according to an embodiment of this application;

FIG. 12 is a schematic flowchart of a data processing method according to an embodiment of this application.

FIG. 13 is a schematic block diagram of a neural network training apparatus according to an embodiment of this application.

FIG. 14 is a schematic block diagram of a data processing apparatus according to an embodiment of this application;

FIG. 15 is a schematic diagram of a hardware structure of a neural network training apparatus according to an embodiment of this application; and

FIG. 16 is a schematic diagram of a hardware structure of a data processing apparatus according to an embodiment of this application.

### DESCRIPTION OF EMBODIMENTS

Terms used in the following embodiments are merely intended to describe specific embodiments, but are not intended to limit this application. As used in the specification and the appended claims of this application, the singular forms “one”, “a”, “the”, “the foregoing”, “the”, and “this” are also intended to include, for example, “one or more”, unless otherwise specified in the context. It should be further understood that in the following embodiments of this application, “at least one” and “one or more” mean one, two, or more. The term “and/or” is used to describe an association relationship between associated objects and represents that three relationships may exist. For example, A and/or B may represent the following cases: Only A exists, both A and B exist, and only B exists, where A and B each may be singular or plural. The character “/” generally indicates an “or” relationship between the associated objects.

Reference to “an embodiment”, “some embodiments”, or the like described in this specification indicates that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “comprise”, “have”, and their variants all mean “include but are not limited to”, unless otherwise specifically emphasized in another manner.

To facilitate understanding of the technical solutions in this application, concepts in this application are first briefly described.

Deep learning (deep learning): Deep learning is a machine learning technology based on a deep neural network algorithm. A main feature of deep learning is to process and analyze data through multiple nonlinear transformations. Deep learning is mainly used in scenarios such as perception and decision-making in the field of artificial intelligence, such as image recognition, speech recognition, natural speech translation, and computer games.

Training (training): Training in embodiments of this application specifically refers to training of a neural network, and generally includes forward calculation of a model output, calculation of a loss based on the model output and a label, backpropagation of a gradient, and parameter update. A model is optimized by using an existing dataset and corresponding labels, a backpropagation algorithm and some parameter update methods to minimize a loss.

Freezing (freezing): In a backpropagation step in a neural network training process, gradients of some parameters are not calculated and these parameters are not updated, that is, reverse freezing is performed on these parameters.

Stopping updating: In a reverse step in the neural network training process, gradients of parameters are continued to be calculated, but these parameters are stopped updating, that is, these parameters are stopped updating.

Costs (costs): Costs in embodiments of this application refer to a resource consumed in the neural network training process, and may be generally calculated based on a calculation amount of a neural network.

The following describes the technical solutions of this application with reference to accompanying drawings.

At present, neural network training is accelerated mainly in hardware upgrade and algorithm optimization. In terms of hardware, higher GPU performance indicates more expensive price. Multi-card parallelism, multi-machine parallelism, and large-scale clustering are also common training acceleration methods. In terms of algorithm, mixed precision training can reduce a calculation amount of a neural network, and accelerate the neural network training effectively in some scenarios. A neural network training method in embodiments of this application mainly relates to algorithm improvement, and can be used to continue to accelerate the training when a hardware condition remains unchanged, and reduce actual costs.

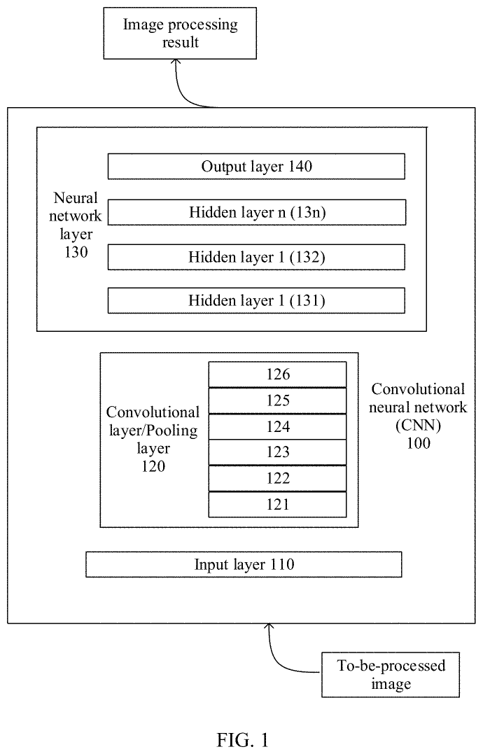

The neural network training method in embodiments of this application is applicable to a convolutional neural network in a structure shown in FIG. 1. In FIG. 1, the convolutional neural network (CNN) 100 may include an input layer 110, a convolutional layer/pooling layer 120 (the pooling layer is optional), and a neural network layer 130. The input layer 110 may obtain to-be-processed data, and send the obtained to-be-processed data to the convolutional layer/pooling layer 120 and the subsequent neural network layer 130 for processing, to obtain a data processing result. The following describes in detail structures of the layers in the CNN 100 in FIG. 1.

Convolutional Layer/Pooling Layer 120

Convolutional Layer

As shown in FIG. 1, for example, the convolutional layer/pooling layer 120 may include layers 121 to 126. For example, in an implementation, the layer 121 is a convolutional layer, the layer 122 is a pooling layer, the layer 123 is a convolutional layer, the layer 124 is a pooling layer, the layer 125 is a convolutional layer, and the layer 126 is a pooling layer. In another implementation, the layer 121 and the layer 122 are convolutional layers, the layer 123 is a pooling layer, the layer 124 and the layer 125 are convolutional layers, and the layer 126 is a pooling layer. That is, an output of a convolutional layer may be used as an input of a subsequent pooling layer, or may be used as an input of another convolutional layer to continue a convolution operation.

The following uses the convolutional layer 121 as an example to describe an internal working principle of one convolutional layer.

The convolutional layer 121 may include a plurality of convolution operators. The convolution operator is also referred to as a kernel. In data processing, the convolution operator functions as a filter that extracts specific information from an input data matrix. The convolution operator may be a weight matrix essentially, and the weight matrix is usually predefined.

Weight values in these weight matrices need to be obtained through a lot of training during actual application. Each weight matrix formed by using the weight values obtained through training may be used to extract information from input data, to enable the convolutional neural network 100 to perform correct prediction.

When the convolutional neural network 100 includes a plurality of convolutional layers, a larger quantity of general features are usually extracted at an initial convolutional layer (for example, the convolutional layer 121). The general features may be also referred to as low-level features. As a depth of the convolutional neural network 100 increases, a feature extracted at a more subsequent convolutional layer (for example, the convolutional layer 126) is more complex, for example, a higher-level semantic feature. A feature with higher semantics is more applicable to a to-be-resolved problem.

Pooling Layer

Because a quantity of training parameters usually needs to be reduced, the pooling layer usually needs to be periodically introduced after a convolutional layer. For the layers 121 to 126 in 120 shown in FIG. 1, one convolutional layer may be followed by one pooling layer, or a plurality of convolutional layers may be followed by one or more pooling layers. During data processing, a sole purpose of the pooling layer is to reduce a space size of data.

Neural Network Layer 130

After processing is performed by the convolutional layer/pooling layer 120, the convolutional neural network 100 still cannot output required output information. As described above, the convolutional layer/pooling layer 120 performs only feature extraction and reduces parameters brought by the input data. However, to generate the final output information (required class information or other related information), the convolutional neural network 100 needs to use the neural network layer 130 to generate an output of one required class or outputs of a group of required classes. Therefore, the neural network layer 130 may include a plurality of hidden layers (131, 132, . . . , and 13n shown in FIG. 1) and an output layer 140. Parameters included in the plurality of hidden layers may be obtained through pre-training based on related training data of a specific task type. For example, the task type may include recognition, classification, or the like.

A neural network may correct a size of a parameter in an initial neural network model in a training process by using an error back propagation (back propagation, BP) algorithm, so that a reconstruction error loss of the neural network model becomes smaller. Specifically, an input signal is transferred forward until an error loss occurs at an output, and the parameter in the initial neural network model is updated based on back propagation error loss information, to make the error loss converge. The back propagation algorithm is an error-loss-centered back propagation motion intended to obtain a parameter, such as a weight matrix, of an optimal neural network model.

The plurality of hidden layers included in the neural network layer 130 are followed by the output layer 140, namely, a last layer of the entire convolutional neural network 100. The output layer 140 has a loss function similar to a categorical cross entropy, and the loss function is specifically for calculating a prediction error. Once forward propagation (for example, propagation from a direction from 110 to 140 in FIG. 1 is forward propagation) of the entire convolutional neural network 100 is completed, back propagation (for example, propagation from a direction from 140 to 110 in FIG. 1 is back propagation) is started to update weight values and deviations of the layers mentioned above, to reduce a loss of the convolutional neural network 100 and an error between a result output by the output layer in the convolutional neural network 100 and an ideal result.

In a conventional neural network training method, network layers are frozen from front to back during training. After a layer is frozen, the layer is not trained until the network training ends. For example, parameters of a neural network are classified into six parts, and are trained for a total of 90 epochs (epochs). A first part corresponds to epochs 1-46, a second part corresponds to epochs 47-53, a third part corresponds to epochs 54-61, a fourth part corresponds to epochs 62-70, a fifth part corresponds to epochs 71-79, and a sixth part corresponds to epochs 80-90. A specific calculation rule is used in the neural network training method. In the first part, each group of parameters is trained on the entire network, that is, gradient calculation and parameter update are performed during back propagation for each parameter in the network. In the second part, first one group of parameters of the neural network is frozen, that is, only forward calculation is included, and gradient calculation and parameter update are not performed during back propagation. In the third part, first two groups of parameters of the neural network are frozen. In the fourth part, first three groups of parameters of the neural network are frozen. In the fifth part, first four groups of parameters of the neural network are frozen. In the sixth part, first five groups of parameters of the neural network are frozen. A learning rate of each group of parameters is scaled based on a ratio of training duration of the group of parameters to total training duration. In the neural network training, the learning rate increases from a last group of parameters to a first group of parameters. This method is only applicable to training of some neural networks. A group of parameters are frozen across a plurality of epochs, and parameter freezing is controlled during training in a coarse-grained manner. A precision loss is large. In addition, the learning rate needs to be scaled based on a proportion corresponding to duration that each group of parameters is frozen, which increases extra workloads.

In another conventional neural network training method, during neural network training, a specific standard is calculated based on a status of a network gradient, and then whether freezing is required is determined according to the standard. In this method, extra calculation workloads are required, and in some scenarios a training speed does not increase but decreases. In still another conventional neural network training method, during network training, a random factor is added, and forward calculation and reverse calculation of a partial residual branch (residual branch) are randomly skipped, to accelerate the training. However, this method can only be applicable to some networks with a specific structure, and has a limited application range.

In the neural network training method in embodiments of this application, parameters of a user network are automatically grouped, and sampling probability distribution is introduced to perform fine-grained freezing control on a training process. Fine interval or periodic arrangement is performed in a training iteration step (training step) dimension, and a momentum offset is corrected, so that each group of parameters of the network is updated at a specific probability in an entire training process. This avoids a case in which a group of parameters is pre-trained, and is totally frozen and no longer updated later, and ensures training precision.

The neural network training method in embodiments of this application is applicable to a deep learning framework such as MindSpore, TensorFlow, or PyTorch, and a scenario in which neural network training in various computer vision (computer vision) tasks needs to be accelerated in cooperation with a hardware platform such as an Ascend chip or a GPU. The computer vision task may be target recognition, target detection, semantic segmentation, and the like.

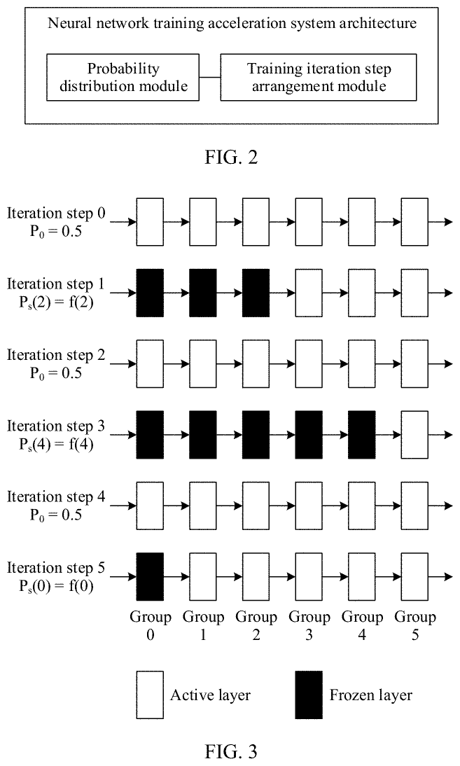

FIG. 2 is a schematic block diagram of a system architecture to which a neural network training method is applicable according to an embodiment of this application. The system architecture can accelerate training of the neural network shown in FIG. 1. As shown in FIG. 2, the system architecture includes a probability distribution module and a training iteration step arrangement module, which are separately described below.

The probability distribution module is configured to introduce sampling probability distribution to perform fine-grained freezing control on a training process, where the probability distribution includes a sampling probability and a freezing probability. The sampling probability is used to control a probability that each group of parameters in the neural network is sampled. For example, if a group of parameters is sampled in a training iteration step, reverse freezing is performed on a first group of parameters from the group of parameters to the network. Once the sampling probability distribution is determined, freezing probability distribution of the parameters is also determined.

A formula of the sampling probability distribution is as follows:

pₛ(i)=f(i)

P(n−1)=0, and ∫₀ⁿ⁻¹f(i)=1.

A formula of the freezing probability distribution is as follows:

p_{freeze}(i)=∫ᵢⁿ⁻¹f(i), and p_{freeze}(0)=1−p₀.

p₀ represents a probability of not freezing any parameter in a neural network training process, that is, a probability of entire network training, n represents a quantity of groups of network parameters, and i represents an exponent of a parameter group, and ranges from 0 to n−1. The formula f (x) may be a continuous function, or a discrete function. For example, a corresponding sampling probability is determined based on an actual test overhead ratio of each group of parameters, a probability that an i^{th} group of parameters is frozen is a sum of sampling probabilities of the i^{th} group to an (n−1)^{th} group of parameters, and a sum of sampling probabilities for all groups of parameters is 1. The larger an area included in a frozen probability distribution curve, the more training overheads are reduced.

The training iteration step arrangement module is configured to perform fine-grained arrangement on training iteration steps based on a probability distribution formula selected by the probability distribution module, to determine to freeze which groups of parameters in each iteration in the training process. FIG. 3 is a schematic diagram of arrangement of training iteration steps with an entire network training probability p₀ of 0.5. Because p₀ is 0.5, entire network training can be performed at every other step, that is, the entire network training is performed at an iteration step 0, an iteration step 2, and an iteration step 4. In an iteration step 1, an iteration step 3, and an iteration step 5, a third group of parameters, a fifth group of parameters, and a first group of parameters are sampled based on sampling probability distribution function distribution, and first three groups of parameters, first five groups of parameters, and first one group of parameters are respectively frozen. This arrangement is referred to as interval arrangement.

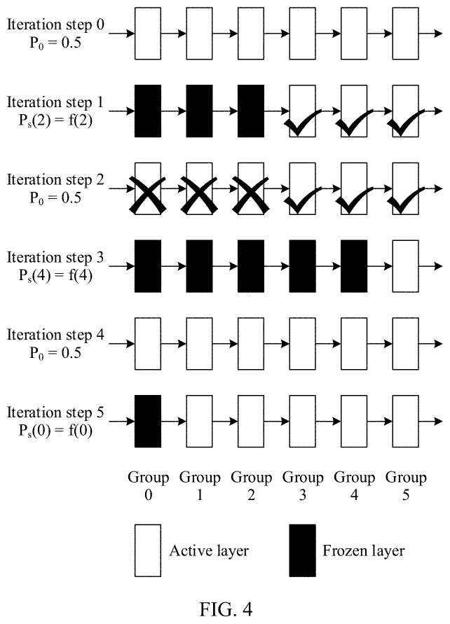

In FIG. 3, an active layer indicates that both forward calculation and reverse calculation are performed, a frozen layer indicates that only forward calculation is performed, and reverse calculation is frozen. Both an active layer and a frozen layer indicate a group of parameters. In the equal-interval arrangement of the entire network training in FIG. 3, a case of a frozen layer thawed in each iteration step occurs, which causes a momentum offset. For example, in FIG. 4, because gradients of first three groups of parameters in an iteration step 2 are missing in an iteration step 1, no momentum is calculated and no parameter update is performed. As a result, momentum used in the iteration step 2 is still momentum in an iteration step 0.

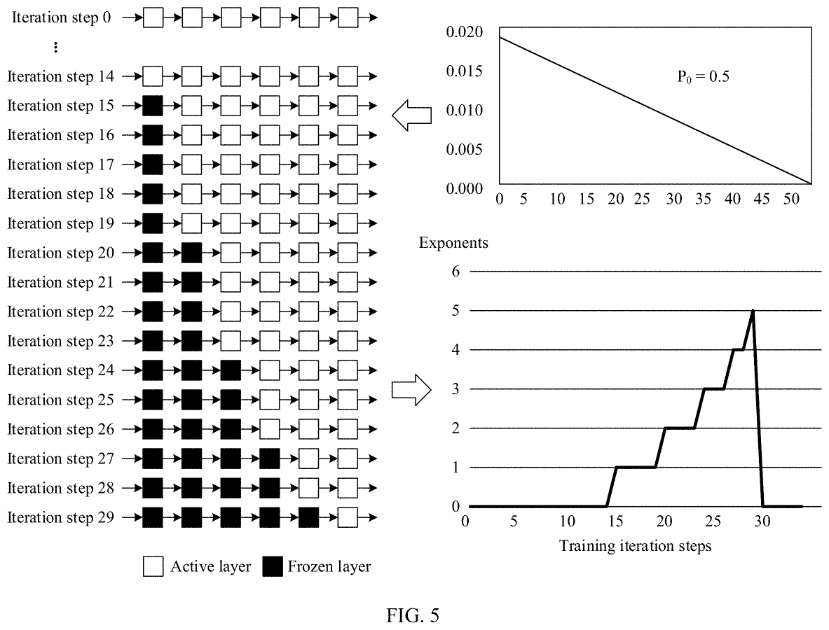

Therefore, in embodiments of this application, a periodic step-by-step freezing arrangement solution (periodic mode) shown in FIG. 5 is designed. An exponent 0 is used to represent entire network training. Exponents 1, 2, 3, 4, and 5 respectively indicate that first one group of parameters, first two groups of parameters, first three groups of parameters, first four groups of parameters, and first five groups of parameters are frozen in a reverse calculation process. A last group of parameters of a network is not frozen. In FIG. 5, iteration step arrangement and an exponential curve are periodic, and a sampling probability decreases linearly, which indicates that there is a higher probability of sampling higher ranking parameter groups. Therefore, a schematic diagram of the training iteration step arrangement on the left in FIG. 5 can be obtained.

For any sampling probability distribution function, the foregoing training iteration step arrangement of interval arrangement and periodic arrangement may be implemented according to a probability of sampling in each step and an entire network training probability. In the interval arrangement, in 10 consecutive training iterations, one or more iteration steps are selected every n iteration steps for frozen sampling, where n may be a manually preset value, or may be determined based on the entire network training probability. For example, in FIG. 3, when p₀ is 0.5, n is 1. Therefore, frozen sampling are performed once every one iteration step. In the periodic arrangement, the iteration step for the entire network training is adjusted based on p₀ and a ratio of p₀ to 1−p₀. For example, in FIG. 5, when p₀ is 0.5, it indicates that a ratio of a quantity of iteration steps for performing entire network training to a quantity of iteration steps for performing frozen sampling is 1 to 1. In this case, iteration steps 0 to 14 correspond to entire network training, and iteration steps 15 to 29 correspond to frozen sampling. Then, it can be learned, based on the sampling probability curve, that there is the higher probability of sampling the higher ranking parameter groups.

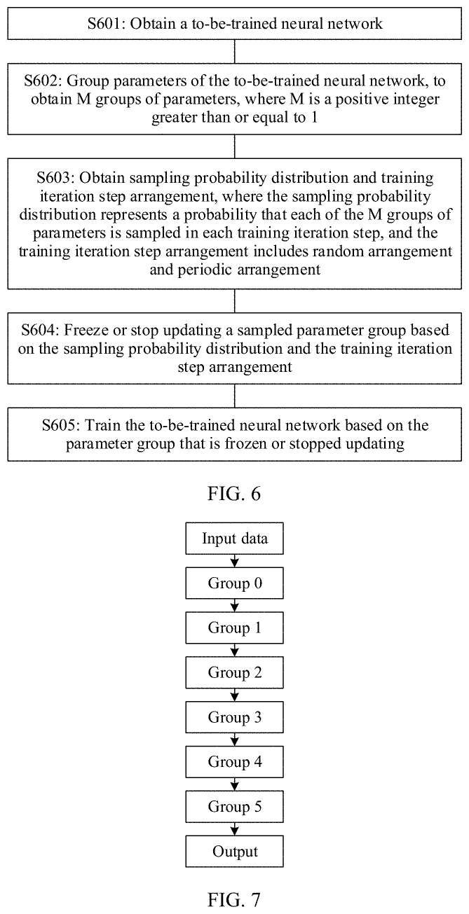

FIG. 6 is a schematic flowchart of a neural network training method according to an embodiment of this application. As shown in FIG. 6, step 601 to step 604 are included, and are separately described below.

S601: Obtain a to-be-trained neural network.

The neural network training method in this embodiment of this application is applicable to tasks such as target detection, image segmentation, natural language processing, and voice recognition. The to-be-trained neural network may be the convolutional neural network shown in FIG. 1, may be specifically a series of neural networks such as ResNet and MobileNet, or may be another neural network. This is not specifically limited in this embodiment of this application.

S602: Group parameters of the to-be-trained neural network, to obtain M groups of parameters, where M is a positive integer greater than or equal to 1

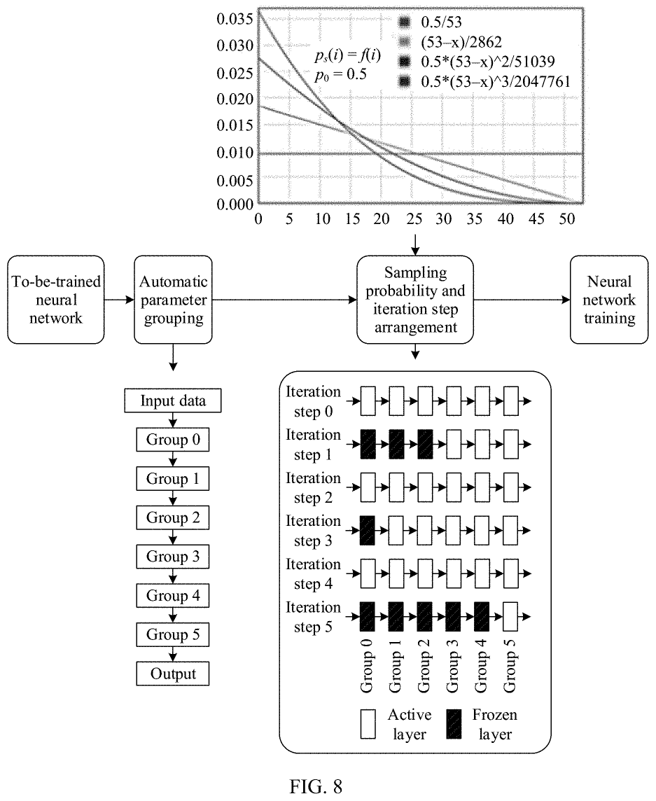

The neural network parameter in this embodiment of this application includes an operator at each layer of the neural network, and training of the neural network is determining a weight of the operator at each layer of the neural network. According to the neural network training method in this embodiment of this application, the parameters of the to-be-trained neural network may be automatically grouped, and a grouping standard may be preset. The parameters are grouped in an input-to-output sequence principle. As shown in FIG. 7, a group of parameters closest to an input is determined as a first group of parameters, namely, a group 0 in FIG. 7, the remaining groups are determined in a similar manner, and a group of parameters farthest away from the input is determined as a last group of parameters, for example, a group 5 in FIG. 7. When the parameters are grouped, a single operator may be grouped into a group of parameters, or a plurality of consecutive operators may be grouped into a group of parameters. Generally, a convolution operator and a followed batch normalization (batch normalization, BN) operator are grouped into a group of parameters. For example, in the series of neural networks such as ResNet and MobileNet in S601, it may be preset that each convolution operator and a BN operator are grouped into one group. In this case, after the series of to-be-trained neural networks such as ResNet and MobileNet are obtained, the neural network training method can be used to automatically group parameters of these neural networks based on preset settings. FIG. 8 is a schematic block diagram of the neural network training method according to this embodiment of this application. As shown in FIG. 8, in the step of automatically grouping the parameters, input data may be automatically grouped into a group 0 to a group 5.

S603: Obtain sampling probability distribution and training iteration step arrangement, where the sampling probability distribution represents a probability that each of the M groups of parameters is sampled in each training iteration step, and the training iteration step arrangement includes interval arrangement and periodic arrangement.

Specifically, the training iteration step arrangement is first determined. In the neural network training method in this embodiment of this application, entire network training is performed on some iteration steps, and entire network training means that gradient calculation and parameter update are performed on each group of parameters in the iteration step. During neural network training, training data is required to minimize a loss function, so as to determine a value of a neural network parameter. To minimize the loss function, an extreme value of the loss function needs to be obtained, but a gradient of a vector field points to a direction in which the function value increases the fastest and opposites to a direction in which the function value decreases the fastest. Therefore, a gradient of the loss function is calculated (that is, partial derivatives of all parameters are calculated) and the parameters are updated in the opposite direction, so that the loss function can quickly reach a minimum value after iteration. Sampling is performed on some iteration steps. Therefore, it is necessary to determine the to-be-sampled iteration steps. The training iteration step arrangement includes the interval arrangement and the periodic arrangement. In the interval arrangement, one or more to-be-sampled training iteration steps of a plurality of to-be-trained iteration steps are determined at a specific interval, for example, determined in the following manner: Determine an entire network training probability p₀. Multiply a quantity of the plurality of to-be-trained iteration steps by p₀ to obtain a quantity of iteration steps to be trained on the entire network. Then, evenly distribute, to the plurality of to-be-trained iteration steps, the iteration steps to be trained on the entire network, where p₀ is a manually preset value, and ranges (0, 1). Table 1 shows some examples of determining training iteration step arrangement based on an entire network training probability.

TABLE 1

| | P₀ = | P₀ = | P₀ = | P₀ = | P₀ = | P₀ = | P₀ = | P₀ = | P₀ = | P₀ = | P₀ = |
|---|---|---|---|---|---|---|---|---|---|---|---|
| | 0 | 0.1 | 0.2 | 0.3 | 0.4 | 0.5 | 0.6 | 0.7 | 0.8 | 0.9 | 1 |
| Step 0 | ♦ | ♦ | ♦ | ♦ | ♦ | ♦ | ⋄ | ⋄ | ⋄ | ⋄ | ⋄ |
| Step 1 | ♦ | ♦ | ♦ | ♦ | ⋄ | ⋄ | ♦ | ⋄ | ⋄ | ⋄ | ⋄ |
| Step 2 | ♦ | ♦ | ♦ | ⋄ | ♦ | ♦ | ⋄ | ♦ | ⋄ | ⋄ | ⋄ |
| Step 3 | ♦ | ♦ | ♦ | ♦ | ⋄ | ⋄ | ♦ | ⋄ | ⋄ | ⋄ | ⋄ |
| Step 4 | ♦ | ♦ | ⋄ | ♦ | ♦ | ♦ | ⋄ | ⋄ | ♦ | ⋄ | ⋄ |
| Step 5 | ♦ | ♦ | ♦ | ⋄ | ⋄ | ⋄ | ♦ | ♦ | ⋄ | ⋄ | ⋄ |
| Step 6 | ♦ | ♦ | ♦ | ♦ | ♦ | ♦ | ⋄ | ⋄ | ⋄ | ⋄ | ⋄ |
| Step 7 | ♦ | ♦ | ♦ | ♦ | ⋄ | ⋄ | ♦ | ⋄ | ⋄ | ⋄ | ⋄ |
| Step 8 | ♦ | ♦ | ♦ | ⋄ | ♦ | ♦ | ⋄ | ♦ | ⋄ | ⋄ | ⋄ |
| Step 9 | ♦ | ⋄ | ⋄ | ♦ | ♦ | ⋄ | ⋄ | ⋄ | ♦ | ♦ | ⋄ |

In Table 1, 10 iteration steps, namely, step 0 to step 9, are used as an example, ♦ indicates that the iteration step is sampled, and ⋄ indicates the iteration step is not sampled, but trained on the entire network. For example, when p₀=0, a quantity of iteration steps trained on the entire network is 0, and all step 0 to step 9 are sampled. For example, when p₀=0.3, a quantity of iteration steps trained on the entire network is 3. The three iteration steps trained on the entire network are evenly distributed to the 10 iteration steps. In this case, step 2, step 5, and step 8 are iteration steps trained on the entire network, and step 0, step 1, step 3, step 4, step 6, step 7, and step 9 are sampled iteration steps. It should be understood that the training iteration step arrangement determined based on the entire network training probability in Table 1 is merely an example of the interval arrangement in this embodiment of this application, and does not constitute a limitation on embodiments of this application.

In the periodic arrangement, a plurality of to-be-trained iteration steps are used as one period, and a quantity of to-be-sampled iteration steps is first determined as M−1. A period is determined with reference to the quantity of to-be-sampled iteration steps and a specific proportion, where one period includes a to-be-sampled iteration step and an iteration step to be trained on the entire network, the specific proportion is a proportion of the to-be-sampled iteration steps in the period, and the to-be-sampled iteration steps are last (M−1) iteration steps in the period. For example, an entire network training probability p₀ may be determined, the entire network training probability p₀ may be a manually preset value, and the specific proportion is 1−p₀. Corresponding to interval arrangement used in FIG. 8, iteration steps 0, 2, and 4 are trained on the entire network, and iteration steps 1, 3, and 5 are sampled iteration steps.

After the to-be-sampled iteration step is determined based on the training iteration step arrangement, a to-be-sampled parameter group is determined in each to-be-sampled iteration step. In the neural network training method in this embodiment of this application, the probability of sampling each of the M groups of parameters in each training iteration step is determined based on the sampling probability distribution, that is, an m^{th} group of parameters sampled in an iteration step is determined based on the sampling probability distribution, where m is less than or equal to M−1. After the sampled m^{th} group of parameters is determined in the iteration step, same processing is performed on the mt group of parameters to a first group of parameters.

S604: Freeze or stop updating a sampled parameter group based on the sampling probability distribution and the training iteration step arrangement.

In S603, processing includes freezing and stopping updating, where freezing indicates that gradient calculation and parameter update are not performed on the m^{th} group of parameters to the first group of parameters, and stopping updating indicates that gradient calculation is performed and parameter update is not performed on the m^{th} group of parameters to the first group of parameters. For corresponding formulas of the sampling probability distribution and the freezing/stopping updating probability distribution, refer to the foregoing description of FIG. 2. For example, in FIG. 8, when p₀ is 0.5, a graph of a plurality of sampling probability distribution curves may be obtained based on the formula of the sampling probability distribution, where a horizontal coordinate represents a parameter group, and a vertical coordinate represents a sampled probability. One of the curves is selected to sample iteration steps 1, 3, and 5. A diagram of sampling distribution of training iteration steps shown in FIG. 8 may be obtained, where if a parameter group sampled in the iteration step 1 is group 2, group 0 and group 1 are frozen; if a parameter group sampled in the iteration step 3 is group 0, group 0 is frozen; if a parameter group sampled in the iteration step 5 is group 4, group 0 to group 4 are frozen.

S605: Train the to-be-trained neural network based on the parameter group that is frozen or stopped updating.

The sampling distribution of the training iteration steps may be obtained based on the sampling probability distribution and the training iteration step arrangement, gradient calculation and parameter update are performed on a parameter group that is not frozen or stopped updating, gradient calculation and parameter update are not performed on frozen parameter groups, and only gradient calculation is performed on the parameter group that is stopped updating, but parameter update is not performed. Therefore, iteration training is performed on the to-be-trained neural network.

It should be understood that the neural network training method in this embodiment of this application is used to train a corresponding neural network, and the neural network may be the neural network shown in FIG. 1. The neural network training method in this embodiment of this application is applicable to visual tasks such as target detection and image segmentation, or applicable to non-visual tasks such as natural language processing and voice recognition.

Complete training is performed on a neural network model in one epoch by using all data in a training set, and parameters of the neural network model is updated once in one training iteration step. In some cases, one epoch may include 10,000 training iteration steps. Therefore, controlling neural network training in a training iteration step dimension has higher precision than that in an epoch dimension.

According to the neural network training method in this embodiment of this application, the parameter group of the neural network is processed in the iteration step dimension, to implement fine-grained control on an acceleration process, and improve training precision while training is accelerated. The parameter groups are sampled and processed based on the training iteration step arrangement and the sampling probability distribution, to more flexibly select between training costs and training precision. For example, a corresponding sampling probability may be determined based on specific costs proportion of each group of parameters. This corrects a momentum offset. For a frozen parameter group, a parameter group in a subsequent iteration step does not need to use, in a period, a parameter of a previously frozen parameter group. Gradient calculation is still performed on the parameter group that is stopped updating, so that a parameter of a parameter group in a subsequent iteration step can be kept updated.

The following describes in detail the neural network training method in this embodiment of this application with reference to specific examples.

The neural network training method in embodiments of this application is applicable to a scenario in which precision of a target recognition task is verified on a plurality of networks separately based on an ImageNet dataset. In a scenario in which a static graph deep learning framework is used, a plurality of reverse paths may be constructed in a computation graph, to accelerate the training in cooperation with the neural network training method in embodiments of this application. For example, the static graph deep learning frameworks such as TensorFlow, and MindSpore are used. In scenarios in which dynamic graph deep learning frameworks are used, reverse truncation can be performed during each reverse process. For example, the dynamic graph deep learning frameworks such as PyTorch are used.

Step 1: Input neural networks ResNet50, ResNet18, and MobileNetV2.

Step 2: Automatically group parameters, and group each convolution operator and a batch normalization (batch normalization, BN) operator into one group.

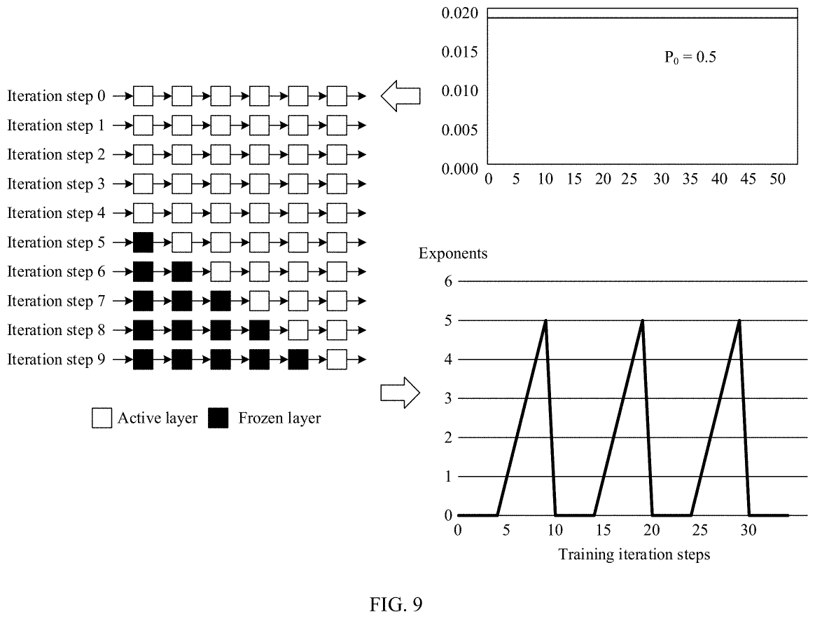

Step 3: Select even sampling probability distribution that has lowest costs and indicates that a probability of sampling each group of parameters is the same, and select periodic arrangement. FIG. 9 is a schematic diagram of sampling training iteration steps in the periodic arrangement according to this embodiment of this application. In a period, an iteration step 0 to an iteration step 4 are trained on an entire network, first one group of parameters is frozen in an iteration step 5, first two groups of parameters are frozen in an iteration step 6, first three groups of parameters are frozen in an iteration step 7, first four groups of parameters are frozen in an iteration step 8, and first five groups of parameters are frozen in an iteration step 9.

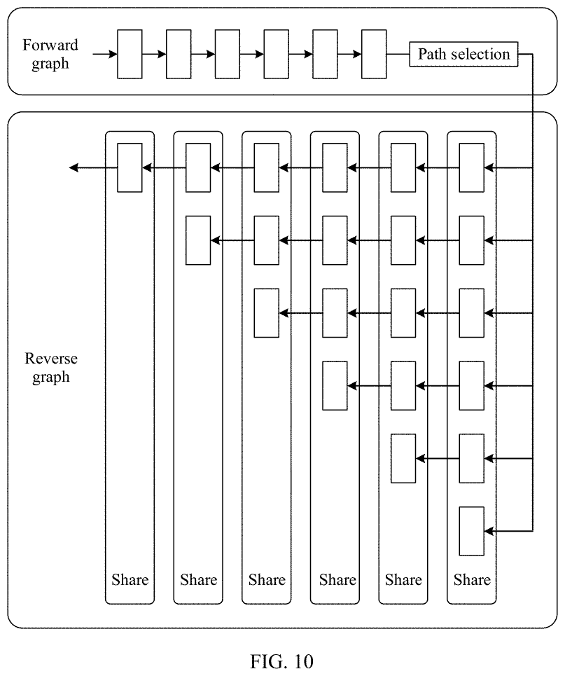

Step 4: Use the deep learning framework TensorFlow to construct the computation graph with the plurality of paths and start iteration training. The computation graph is shown in FIG. 10.

The neural network training method is used to train and evaluate different networks based on the ImageNet dataset, and precision test results obtained are shown in the following table.

TABLE 2

| | Baseline (%) | Precision (%) | |
|---|---|---|---|
| ResNet50 | 76.81 | 76.92 | (+0.11) |
| ResNet34 | 74.43 | 74.38 | (−0.05) |
| ResNet18 | 70.7 | 70.98 | (+0.28) |
| ResNet101 | 78.84 | 78.85 | (+0.01) |
| MobileNetV2 | 71.96 | 72.04 | (+0.08) |
| Vgg16_bn | 73.82 | 73.55 | (−0.27) |
| ResNeXt50 | 77.68 | 77.64 | (−0.04) |
| DenseNet121 | 75.84 | 75.82 | (−0.02) |
| AlexNet | 57.02 | 56.98 | (−0.04) |
| Inception V3 | 76.20 | 76.15 | (−0.05) |

It can be learned from Table 2 that precision obtained by training different networks based on the ImageNet dataset by using the neural network training method is basically the same as the baseline, but a neural network training speed is increased by 20%.

According to the neural network training method in this embodiment of this application, regularization effect can be achieved in a recognition-type task, and effect of improving model precision to some extent is achieved while costs are slightly reduced. The following describes another process of training a network by using the neural network training method in this embodiment of this application.

Step 1: Input neural networks ResNet50, ResNet18, and MobileNetV2.

Step 2: Automatically group parameters, and group each convolution operator and a batch normalization (batch normalization, BN) operator into one group.

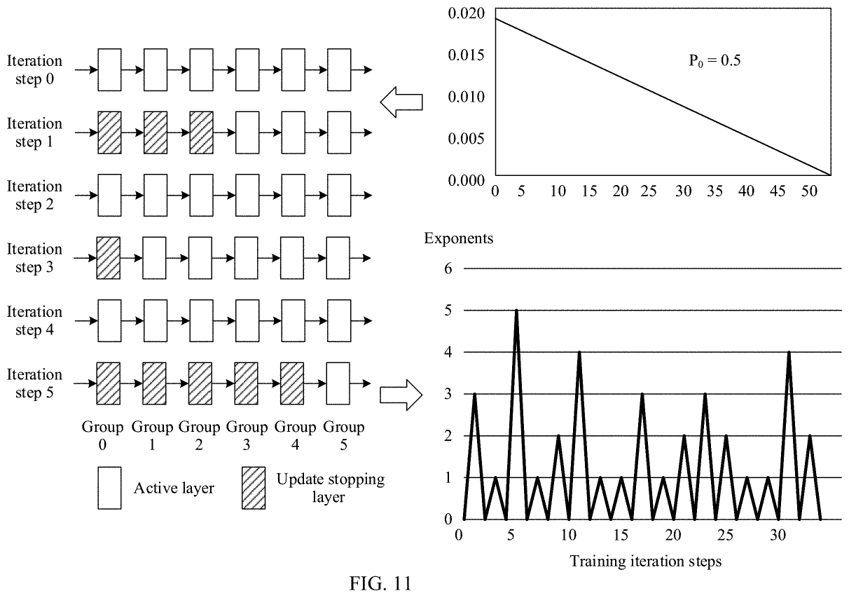

Step 3: Select linearly decreasing sampling probability distribution that indicates a higher probability of sampling a higher ranking parameter group, and select training iteration step arrangement as interval arrangement. Gradients and momentum are still calculated for sampled parameters, so that a momentum offset of the corresponding parameter groups in a next iteration step can be avoided, but parameter update is not performed. Because specific noise is introduced due to randomness of stochastic gradient descent (stochastic gradient descent, SGD), in a normal training process of the network, a useful signal brought by the gradient transferred based on a loss to a previous layer is already very weak. As a result, a signal-to-noise ratio of a front layer of the network is high. In the interval arrangement, gradient update of the front layer is randomly stopped. This helps reduce negative effect caused by the high signal-to-noise ratio, plays an optimization role, and improves precision of the trained neural network. FIG. 11 is a schematic diagram of sampling training iteration steps in interval arrangement according to an embodiment of this application.

The neural network training method is used to train and evaluate different networks based on the ImageNet dataset, and precision test results obtained are shown in the following table.

TABLE 3

| | Baseline (%) | Precision (%) | |
|---|---|---|---|
| ResNet50 | 76.81 | 77.05 | (+0.24) |
| ResNet34 | 74.43 | 76.60 | (+0.07) |
| ResNet18 | 70.7 | 71.02 | (+0.32) |
| ResNet101 | 78.84 | 79.10 | (+0.26) |
| MobileNetV2 | 71.96 | 72.14 | (+0.18) |
| Vgg16_bn | 73.82 | 74.05 | (+0.23) |
| ResNeXt50 | 77.68 | 78.01 | (+0.33) |
| DenseNet121 | 75.84 | 75.78 | (−0.06) |
| AlexNet | 57.02 | 56.69 | (−0.33) |
| Inception V3 | 76.20 | 76.41 | (−0.21) |

It can be learned from Table 3 that, compared with a baseline, precision obtained by training different networks based on the ImageNet dataset by using the neural network training method is basically improved to some extent.

Different from a conventional regularization method, the neural network training method in this embodiment of this application can slightly reduce costs without changing a user network structure, and improve precision based on the specific sampling probability distribution and parameter stopping updating.

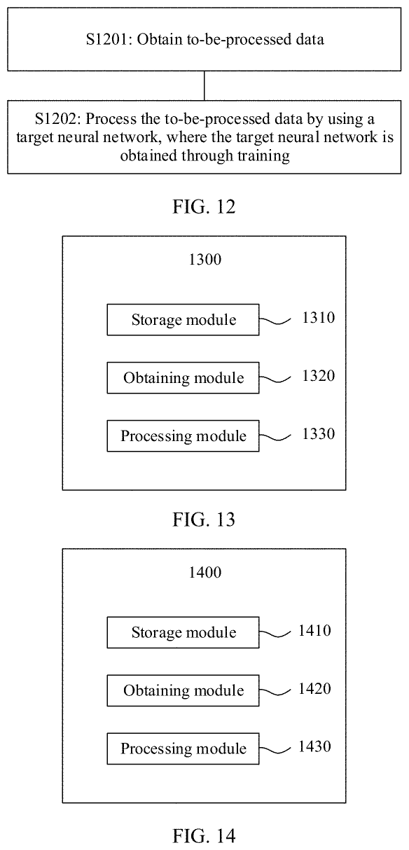

FIG. 12 is a schematic flowchart of a data processing method according to an embodiment. The method includes step 1201 and step 1202.

S1201: Obtain to-be-processed data.

S1202: Process the to-be-processed data by using a target neural network, where the target neural network is obtained through training, and the training of the target neural network includes: obtaining the to-be-trained neural network; grouping parameters of the to-be-trained neural network, to obtain M groups of parameters, where M is a positive integer greater than or equal to 1; obtaining sampling probability distribution and training iteration step arrangement, where the sampling probability distribution represents a probability that each of the M groups of parameters is sampled in each training iteration step, and the training iteration step arrangement includes interval arrangement and periodic arrangement; freezing or stopping updating a sampled parameter group based on the sampling probability distribution and the training iteration step arrangement; and training the to-be-trained neural network based on the parameter group that is frozen or stopped updating.

The neural network for data processing in FIG. 12 is obtained through the training according to the neural network training method in FIG. 6. For the training of the neural network, refer to the foregoing description of FIG. 6. For brevity, details are not described herein again in this embodiment of this application.

The foregoing describes in detail the neural network training method in embodiments of this application, and the following describes related apparatuses in embodiments of this application with reference to FIG. 13 to FIG. 16.

FIG. 13 is a schematic block diagram of a neural network training apparatus according to an embodiment of this application. The apparatus includes a storage module 1310, an obtaining module 1320, and a processing module 1330, and the modules are separately described below.

The storage module 1310 is configured to store a program.

The obtaining module 1320 is configured to obtain a to-be-trained neural network.

The processing module 1330 is configured to group parameters of the to-be-trained neural network, to obtain M groups of parameters, where M is a positive integer greater than or equal to 1.

The obtaining module 1320 is further configured to obtain sampling probability distribution and training iteration step arrangement, where the sampling probability distribution represents a probability that each of the M groups of parameters is sampled in each training iteration step, and the training iteration step arrangement includes interval arrangement and periodic arrangement.

The processing module 1330 is further configured to freeze or stop updating a sampled parameter group based on the sampling probability distribution and the training iteration step arrangement, and train the to-be-trained neural network based on the parameter group that is frozen or stopped updating.

Optionally, when freezing or stopping updating the sampled parameter group based on the sampling probability distribution and the training iteration step arrangement, the processing module 1330 is specifically configured to: determine a first iteration step based on the training iteration step arrangement; determine, based on the sampling probability distribution, an m^{th} group of parameters sampled in the first iteration step, where m is less than or equal to M−1; and freeze the m^{th} group of parameters to a first group of parameters in the first iteration step, where the freezing the m^{th} group of parameters to a first group of parameters in the first iteration step indicates that gradient calculation and parameter update are not performed on the m^{th} group of parameters to the first group of parameters.

Optionally, when freezing or stopping updating the sampled parameter group based on the sampling probability distribution and the training iteration step arrangement, the processing module 1330 is specifically configured to: determine a first sampled iteration step based on the training iteration step arrangement; determine, based on the sampling probability distribution, an m^{th} group of parameters sampled in the first iteration step, where m is less than or equal to M−1; and stop updating the m^{th} group of parameters to a first group of parameters in the first iteration step, where the stopping updating the m^{th} group of parameters to a first group of parameters in the first iteration step indicates that gradient calculation is performed and parameter update is not performed on the m^{th} group of parameters to the first group of parameters.

Optionally, when the training iteration step arrangement is the interval arrangement, when determining the first sampled iteration step based on the training iteration step arrangement, the processing module 1130 is specifically configured to: determine a first interval; and determine one or more first iteration steps at every first interval in a plurality of training iteration steps. Optionally, when the training iteration step arrangement is the periodic arrangement, that the processing module 1130 determines the first sampled iteration step based on the training iteration step arrangement includes: determining that a quantity of first iteration steps is M−1; and determining a first period based on the quantity of first iteration steps and a first proportion, where the first period includes the first iteration step and an iteration step to be trained on the entire network, the first proportion is a proportion of the first iteration step in the first period, and the first iteration step is last (M−1) iteration steps in the first period.

It should be understood that the neural network training apparatus 1300 in this embodiment of this application may be configured to implement steps in the method in FIG. 6. For specific implementation, refer to the foregoing description of the method in FIG. 6. For brevity, details are not described herein again in this embodiment of this application.

FIG. 14 is a schematic block diagram of a data processing apparatus according to an embodiment of this application. The apparatus includes a storage module 1410, an obtaining module 1420, and a processing module 1430, and the modules are separately described below.

The storage module 1410 is configured to store a program.

The obtaining module 1420 is configured to obtain to-be-processed data.

The processing module 1430 is configured to process the to-be-processed data by using a target neural network, where the target neural network is obtained through training, and the training of the target neural network includes: obtaining the to-be-trained neural network; grouping parameters of the to-be-trained neural network, to obtain M groups of parameters, where M is a positive integer greater than or equal to 1; obtaining sampling probability distribution and training iteration step arrangement, where the sampling probability distribution represents a probability that each of the M groups of parameters is sampled in each training iteration step, and the training iteration step arrangement includes interval arrangement and periodic arrangement; freezing or stopping updating a sampled parameter group based on the sampling probability distribution and the training iteration step arrangement; and training the to-be-trained neural network based on the parameter group that is frozen or stopped updating.

It should be understood that the neural network training apparatus 1400 in this embodiment of this application may be configured to implement steps in the method in FIG. 12. For specific implementation, refer to the foregoing description of the method in FIG. 12. For brevity, details are not described herein again in this embodiment of this application.

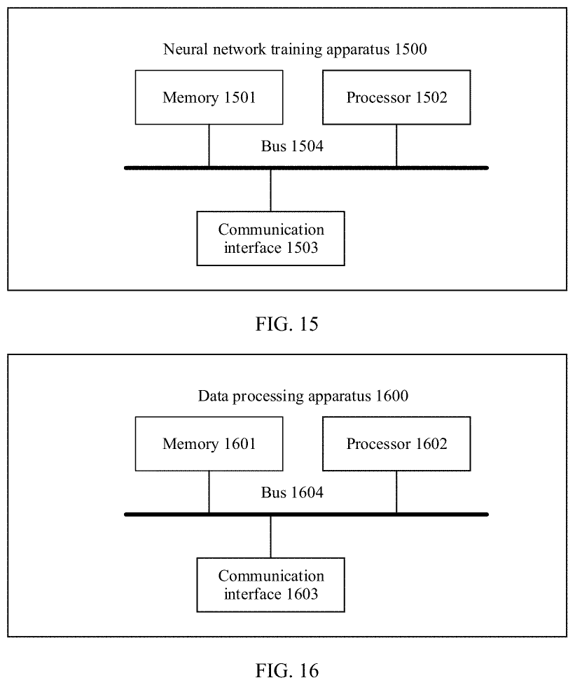

FIG. 15 is a schematic diagram of a hardware structure of a neural network training apparatus 1500 according to an embodiment of this application. As shown in FIG. 15, the apparatus includes a memory 1501, a processor 1502, a communication interface 1503, and a bus 1504. Communication connections between the memory 1501, the processor 1502, and the communication interface 1503 are implemented through the bus 1504.

The memory 1501 may be a ROM, a static storage device, and a RAM. The memory 1501 may store a program. When the program stored in the memory 1501 is executed by the processor 1502, the processor 1502 and the communication interface 1503 are configured to perform steps of the neural network training method in embodiments of this application.

The processor 1502 may be a general-purpose CPU, a microprocessor, an ASIC, a GPU, or one or more integrated circuits, and is configured to execute a related program, to implement functions that need to be performed by units in the neural network training apparatus in embodiments of this application, or perform the neural network training method in the method embodiments of this application.

Alternatively, the processor 1502 may be an integrated circuit chip and has a signal processing capability. For example, the processor may be the chip shown in FIG. 4. In an implementation process, steps of the neural network training method in embodiments of this application may be accomplished by using a hardware integrated logic circuit in the processor 1502 or instructions in a form of software.

The processor 1502 may alternatively be a general-purpose processor, a DSP, an ASIC, an FPGA or another programmable logic device, a discrete gate or transistor logic device, or a discrete hardware component. The processor may implement or perform the methods, the steps, and logical block diagrams that are disclosed in embodiments of this application. The general-purpose processor may be a microprocessor, or the processor may be any conventional processor or the like. Steps of the methods disclosed with reference to embodiments of this application may be directly executed and accomplished by a hardware decoding processor, or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, or a register. The storage medium is located in the memory 1501. The processor 1502 reads information in the memory 1501, and implements, in combination with hardware of the processor, the function that needs to be performed by the unit included in the neural network training apparatus in embodiments of this application, or performs the neural network training method in the method embodiments of this application.

The communication interface 1503 uses a transceiver apparatus, for example, but not limited to, a transceiver, to implement communication between the apparatus 1500 and another device or a communications network. For example, a to-be-trained neural network may be obtained through the communication interface 1503.

The bus 1504 may include a channel for transmitting information between components (for example, the memory 1501, the processor 1502, and the communication interface 1503) of the apparatus 1500.

FIG. 16 is a schematic diagram of a hardware structure of a data processing apparatus 1600 according to an embodiment of this application. The apparatus includes a memory 1601, a processor 1602, a communication interface 1603, and a bus 1604. Communication connections between the memory 1601, the processor 1602, and the communication interface 1603 are implemented through the bus 1604.

The memory 1601 may be a ROM, a static storage device, and a RAM. The memory 1601 may store a program. When the program stored in the memory 1601 is executed by the processor 1602, the processor 1602 and the communication interface 1603 are configured to perform the steps of the data processing method in embodiments of this application.

The processor 1602 may be a general-purpose CPU, a microprocessor, an ASIC, a GPU, or one or more integrated circuits, and is configured to execute a related program, to implement a function that needs to be executed by a unit in the data processing apparatus in embodiments of this application, or perform the data processing method in the method embodiments of this application.

The processor 1602 may alternatively be an integrated circuit chip and has a signal processing capability. In an implementation process, the steps of the data processing method in embodiments of this application may be completed by using a hardware integrated logic circuit in the processor 1602 or instructions in a form of software.

The processor 1602 may alternatively be a general-purpose processor, a DSP, an ASIC, an FPGA or another programmable logic device, a discrete gate or transistor logic device, or a discrete hardware component. The processor may implement or perform the methods, the steps, and logical block diagrams that are disclosed in embodiments of this application. The general-purpose processor may be a microprocessor, or the processor may be any conventional processor or the like. Steps of the methods disclosed with reference to embodiments of this application may be directly executed and accomplished by a hardware decoding processor, or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, or a register. The storage medium is located in the memory 1601. The processor 1602 reads information in the memory 1601, and completes, in combination with hardware of the processor, a function that needs to be performed by a unit included in the data processing apparatus in embodiments of this application, or performs the data processing method in the method embodiments of this application.

The communication interface 1603 uses a transceiver apparatus, for example, but not limited to, a transceiver, to implement communication between the apparatus 1600 and another device or a communications network. For example, to-be-processed data may be obtained through the communication interface 1603.

The bus 1604 may include a path for transmitting information between components (for example, the memory 1601, the processor 1602, and the communication interface 1603) of the apparatus 1600.

It should be noted that although only the memory, the processor, and the communication interface in the apparatuses 1500 and 1600 are illustrated, in a specific implementation process, a person skilled in the art should understand that the apparatuses 1500 and 1600 may further include another component necessary for normal running. In addition, according to a specific requirement, a person skilled in the art should understand that the apparatuses 1500 and 1600 may further include hardware components for implementing other additional functions. In addition, a person skilled in the art should understand that the apparatuses 1500 and 1600 each may include only components necessary for implementing embodiments of this application, but not necessarily include all the components shown in FIG. 15 and FIG. 16.

It should be understood that, the processor in embodiments of this application may be a central processing unit (central processing unit, CPU). The processor may be another general-purpose processor, a digital signal processor (digital signal processor, DSP), an application-specific integrated circuit (application-specific integrated circuit, ASIC), a field programmable gate array (field programmable gate array, FPGA), or another programmable logic device, discrete gate or transistor logic device, discrete hardware component, or the like. The general-purpose processor may be a microprocessor, or the processor may be any conventional processor or the like.

It may be understood that the memory in embodiments of this application may be a volatile memory or a nonvolatile memory, or may include a volatile memory and a nonvolatile memory. The nonvolatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), used as an external cache. By way of example and not limitation, random access memories (random access memories, RAMs) in many forms may be used, for example, a static random access memory (static RAM, SRAM), a dynamic random access memory (dynamic random access memory, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

An embodiment of this application further provides a computer program product. When the computer program product is executed by the processors 1502 and 1602, the method in any method embodiment of this application is implemented. The computer program product may be stored in the memories 1501 and 1601, and the program is finally converted into an executable target file that can be executed by the processors 1502 and 1602 after processing processes such as preprocessing, compilation, assembly, and linking.

An embodiment of this application further provides a computer-readable storage medium. The computer-readable storage medium stores a computer program. When the computer program is executed by a computer, the method in any method embodiment of this application is implemented. The computer program may be a high-level language program, or may be an executable target program. The computer-readable storage medium is, for example, the memories 1501 and 1601.

An embodiment of this application further provides a chip. The chip includes a processor and a data interface. The processor reads, through the data interface, instructions stored in a memory, to perform the method in any method embodiment of this application.

All or some of the foregoing embodiments may be implemented using software, hardware, firmware, or any combination thereof. When software is used to implement embodiments, all or some of the foregoing embodiments may be implemented in a form of a computer program product. The computer program product includes one or more computer instructions or computer programs. When the program instructions or the computer programs are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another web site, computer, server, or data center in a wired (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It should be understood that the term “and/or” in this specification describes only an association relationship between associated objects and represents that three relationships may exist. For example, A and/or B may represent the following three cases: only A exists, both A and B exist, and only B exists. A and B may be singular or plural. In addition, the character “/” in this specification usually indicates an “or” relationship between the associated objects, but may also indicate an “and/or” relationship. For details, refer to the context for understanding.

In this application, “at least one” means one or more, and “a plurality of” means two or more. “At least one of the following items (pieces)” or a similar expression thereof indicates any combination of these items, including a single item (piece) or any combination of a plurality of items (pieces). For example, at least one item (piece) of a, b, or c may represent: a, b, c, a and b, a and c, b and c, or a, b, and c, where a, b, and c may be singular or plural.

It should be understood that sequence numbers of the foregoing processes do not mean execution sequences in various embodiments of this application. The execution sequences of the processes should be determined according to functions and internal logic of the processes, and should not be construed as any limitation on the implementation processes of embodiments of this application.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of embodiments.

In addition, functional units in embodiments of this application may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A neural network training method, comprising:
obtaining a to-be-trained neural network;
grouping parameters of the to-be-trained neural network, to obtain M groups of parameters, wherein M is a positive integer greater than or equal to 1;
obtaining sampling probability distribution and training iteration step arrangement, wherein the sampling probability distribution represents a probability that each of the M groups of parameters is sampled in each training iteration step, and the training iteration step arrangement comprises interval arrangement and periodic arrangement;
freezing or stopping updating a sampled parameter group based on the sampling probability distribution and the training iteration step arrangement; and
training the to-be-trained neural network based on the parameter group that is frozen or stopped updating.

2. The method according to claim 1, wherein the freezing or stopping updating a sampled parameter group based on the sampling probability distribution and the training iteration step arrangement comprises:
determining a first iteration step based on the training iteration step arrangement, wherein the first iteration step is a to-be-sampled iteration step;
determining, based on the sampling probability distribution, an m^{th} group of parameters sampled in the first iteration step, wherein m is less than or equal to M−1; and
freezing the m^{th} group of parameters to a first group of parameters in the first iteration step, wherein the freezing the m^{th} group of parameters to a first group of parameters in the first iteration step indicates that gradient calculation and parameter update are not performed on the m^{th} group of parameters to the first group of parameters.

3. The method according to claim 1, wherein the freezing or stopping updating a sampled parameter group based on the sampling probability distribution and the training iteration step arrangement comprises:
determining a first iteration step based on the training iteration step arrangement, wherein the first iteration step is a to-be-sampled iteration step;
determining, based on the sampling probability distribution, an m^{th} group of parameters sampled in the first iteration step, wherein m is less than or equal to M−1; and
stopping updating the m^{th} group of parameters to a first group of parameters in the first iteration step, wherein the stopping updating the m^{th} group of parameters to a first group of parameters in the first iteration step indicates that gradient calculation is performed and parameter update is not performed on the m^{th} group of parameters to the first group of parameters.

4. The method according to claim 2, wherein when the training iteration step arrangement is the interval arrangement, the determining a first iteration step based on the training iteration step arrangement comprises:
determining a first interval; and
determining one or more first iteration steps at every first interval in a plurality of training iteration steps.

5. The method according to claim 3, wherein when the training iteration step arrangement is the interval arrangement, the determining a first iteration step based on the training iteration step arrangement comprises:
determining a first interval; and
determining one or more first iteration steps at every first interval in a plurality of training iteration steps.

6. The method according to claim 2, wherein when the training iteration step arrangement is the periodic arrangement, the determining a first iteration step based on the training iteration step arrangement comprises:
determining that a quantity of first iteration steps is M−1; and
determining a first period based on the quantity of first iteration steps and a first proportion, wherein the first period comprises the first iteration step and an iteration step to be trained on the entire network, the first proportion is a proportion of the first iteration step in the first period, and the first iteration step is last (M−1) iteration steps in the first period.

7. The method according to claim 3, wherein when the training iteration step arrangement is the periodic arrangement, the determining a first iteration step based on the training iteration step arrangement comprises:
determining that a quantity of first iteration steps is M−1; and
determining a first period based on the quantity of first iteration steps and a first proportion, wherein the first period comprises the first iteration step and an iteration step to be trained on the entire network, the first proportion is a proportion of the first iteration step in the first period, and the first iteration step is last (M−1) iteration steps in the first period.

8. A neural network training apparatus, comprising:
an obtaining module, configured to obtain a to-be-trained neural network; and
a processing module, configured to group parameters of the to-be-trained neural network, to obtain M groups of parameters, wherein M is a positive integer greater than or equal to 1, wherein
the obtaining module is further configured to obtain sampling probability distribution and training iteration step arrangement, wherein the sampling probability distribution represents a probability that each of the M groups of parameters is sampled in each training iteration step, and the training iteration step arrangement comprises interval arrangement and periodic arrangement; and
the processing module is further configured to: freeze or stop updating a sampled parameter group based on the sampling probability distribution and the training iteration step arrangement; and
train the to-be-trained neural network based on the parameter group that is frozen or stopped updating.

9. The apparatus according to claim 8, wherein that the processing module freezes or stops updating a sampled parameter group based on the sampling probability distribution and the training iteration step arrangement comprises:
determining a first iteration step based on the training iteration step arrangement, wherein the first iteration step is a to-be-sampled iteration step;
determining, based on the sampling probability distribution, an m^{th} group of parameters sampled in the first iteration step, wherein m is less than or equal to M−1; and
freezing the m^{th} group of parameters to a first group of parameters in the first iteration step, wherein the freezing the m^{th} group of parameters to a first group of parameters in the first iteration step indicates that gradient calculation and parameter update are not performed on the m^{th} group of parameters to the first group of parameters.

10. The apparatus according to claim 8, wherein that the processing module freezes or stops updating a sampled parameter group based on the sampling probability distribution and the training iteration step arrangement comprises:
determining a first iteration step based on the training iteration step arrangement, wherein the first iteration step is a to-be-sampled iteration step;
determining, based on the sampling probability distribution, an m^{th} group of parameters sampled in the first iteration step, wherein m is less than or equal to M−1; and
stopping updating the m^{th} group of parameters to a first group of parameters in the first iteration step, wherein the stopping updating the m^{th} group of parameters to a first group of parameters in the first iteration step indicates that gradient calculation is performed and parameter update is not performed on the m^{th} group of parameters to the first group of parameters.

11. The apparatus according to claim 9 wherein when the training iteration step arrangement is the interval arrangement, that the processing module determines a first iteration step based on the training iteration step arrangement comprises:
determining a first interval; and
determining one or more first iteration steps at every first interval in a plurality of training iteration steps.

12. The apparatus according to claim 10, wherein when the training iteration step arrangement is the interval arrangement, that the processing module determines a first iteration step based on the training iteration step arrangement comprises:
determining a first interval; and
determining one or more first iteration steps at every first interval in a plurality of training iteration steps.

13. The apparatus according to claim 9, wherein when the training iteration step arrangement is the periodic arrangement, that the processing module determines a first iteration step based on the training iteration step arrangement comprises:
determining that a quantity of first iteration steps is M−1; and
determining a first period based on the quantity of first iteration steps and a first proportion, wherein the first period comprises the first iteration step and an iteration step to be trained on the entire network, the first proportion is a proportion of the first iteration step in the first period, and the first iteration step is last (M−1) iteration steps in the first period.

14. The apparatus according to claim 10, wherein when the training iteration step arrangement is the periodic arrangement, that the processing module determines a first iteration step based on the training iteration step arrangement comprises:
determining that a quantity of first iteration steps is M−1; and
determining a first period based on the quantity of first iteration steps and a first proportion, wherein the first period comprises the first iteration step and an iteration step to be trained on the entire network, the first proportion is a proportion of the first iteration step in the first period, and the first iteration step is last (M−1) iteration steps in the first period.

15. A computer-readable storage medium, wherein the computer-readable medium stores program code executed by a device, and when the program code is executed by the device, the device is enabled to perform the following operations:
obtaining a to-be-trained neural network;
grouping parameters of the to-be-trained neural network, to obtain M groups of parameters, wherein M is a positive integer greater than or equal to 1;
obtaining sampling probability distribution and training iteration step arrangement, wherein the sampling probability distribution represents a probability that each of the M groups of parameters is sampled in each training iteration step, and the training iteration step arrangement comprises interval arrangement and periodic arrangement;
freezing or stopping updating a sampled parameter group based on the sampling probability distribution and the training iteration step arrangement; and
training the to-be-trained neural network based on the parameter group that is frozen or stopped updating.

16. The medium of claim 15, wherein the freezing or stopping updating a sampled parameter group based on the sampling probability distribution and the training iteration step arrangement comprises:
determining a first iteration step based on the training iteration step arrangement, wherein the first iteration step is a to-be-sampled iteration step;
determining, based on the sampling probability distribution, an m^{th} group of parameters sampled in the first iteration step, wherein m is less than or equal to M−1; and
freezing the m^{th} group of parameters to a first group of parameters in the first iteration step, wherein the freezing the m^{th} group of parameters to a first group of parameters in the first iteration step indicates that gradient calculation and parameter update are not performed on the m^{th} group of parameters to the first group of parameters.

17. The medium of claim 15, wherein the freezing or stopping updating a sampled parameter group based on the sampling probability distribution and the training iteration step arrangement comprises:
determining a first iteration step based on the training iteration step arrangement, wherein the first iteration step is a to-be-sampled iteration step;
determining, based on the sampling probability distribution, an m^{th} group of parameters sampled in the first iteration step, wherein m is less than or equal to M−1; and
stopping updating the m^{th} group of parameters to a first group of parameters in the first iteration step, wherein the stopping updating the m^{th} group of parameters to a first group of parameters in the first iteration step indicates that gradient calculation is performed and parameter update is not performed on the m^{th} group of parameters to the first group of parameters.

18. The medium of claim 16, wherein when the training iteration step arrangement is the interval arrangement, the determining a first iteration step based on the training iteration step arrangement comprises:
determining a first interval; and
determining one or more first iteration steps at every first interval in a plurality of training iteration steps.

19. The medium of claim 17, wherein when the training iteration step arrangement is the interval arrangement, the determining a first iteration step based on the training iteration step arrangement comprises:
determining a first interval; and
determining one or more first iteration steps at every first interval in a plurality of training iteration steps.

20. The medium of claim 16, wherein when the training iteration step arrangement is the periodic arrangement, the determining a first iteration step based on the training iteration step arrangement comprises:
determining that a quantity of first iteration steps is M−1; and
determining a first period based on the quantity of first iteration steps and a first proportion, wherein the first period comprises the first iteration step and an iteration step to be trained on the entire network, the first proportion is a proportion of the first iteration step in the first period, and the first iteration step is last (M−1) iteration steps in the first period.
